(19) United States
(12) Patent Application Publication
(10) Pub. No.: US 2024/0411059 A1
(43) Pub. Date: Dec. 12, 2024

(54) IMAGING SYSTEMS INCLUDING A META OPTICAL ELEMENT THAT HAS A PHASE FUNCTION INCLUDING BOTH DIVERGING AND CONVERGING OPTICAL CHARACTERISTICS

(71) Applicant: NIL Technology ApS, Kongens Lyngby (DK)

(72) Inventor: Fredrik Mattinson, Täby (SE)

(21) Appl. No.: 18/699,764

(22) PCT Filed: Oct. 7, 2022
(86) PCT No.: PCT/EP2022/077913

§ 371 Date: Apr. 9, 2024

Related U.S. Application Data
(60) Provisional application No. 63/254,889, filed on Oct. 12, 2021.

(51) Int. Cl. G02B 3/08; G02B 1/02

(52) U.S. Cl. CPC G02B 3/08; G02B 1/02

(57) ABSTRACT

An apparatus and imaging system are disclosed and include a meta optical element having a phase function having both diverging and converging optical characteristics. In some instances, the apparatus or imaging system includes a lens system including at least one lens, wherein the meta optical element is optically aligned with the at least one lens.

### FIELD OF THE DISCLOSURE

The present disclosure relates to imaging systems that include a meta optical element.

### BACKGROUND

Mobile phone camera lens systems sometimes include a stack of polymeric refractive lenses. The stack may include a field corrector lens that counters the field-angle dependence of the focal length of the system. The field corrector lens may have, for example, a lens surface that includes both concave and convex portions. Lenses with concave and convex portions on the same surface are sometimes referred to as having an S-shape or having an S-form. The concave portion of the lens surface corresponds to a diverging portion of the lens's phase function. That is, light waves passing through the concave portion diverge, or are scattered away from, a focal point or centerline. This divergence occurs because the lens is thinner in the center and thicker toward the periphery, causing light entering the lens to be refracted away from its center. On the other hand, the convex portion of the lens surface corresponds to a converging portion of the lens's phase function. That is, the converging portion causes light rays to converge, or concentrate, to form a real image.

### SUMMARY

The present disclosure describes apparatus and imaging systems that include a meta optical element having a phase function that has both diverging and converging optical characteristics.

In some implementations, the apparatus also includes a lens system that includes at least one lens, wherein the meta optical element is optically aligned with the at least one lens. In some instances, the at least one lens includes one or more of a refractive lens, a diffractive lens, a GRIN lens, and/or a metalens. In some instances, the lens system includes a stack of two or more lenses.

Some implementations include one or more of the following features. For example, the meta optical element can be a metalens that has a metasurface comprising meta-atoms. In some cases, the meta optical element is composed of an inorganic material, or is composed of silicon on a glass substrate. In some instances, the phase function has a diverging optical characteristic near a periphery of the meta optical element and a converging optical characteristic near a center region of the meta optical element.

In some instances, the apparatus also includes an image sensor optically aligned with the lens system and the meta optical element. For example, the present disclosure also describes an imaging system that includes a lens system including at least one lens, and a meta optical element optically aligned with the at least one lens. The imaging system further includes an image sensor optically aligned with the lens system and the meta optical element. The meta optical element has a phase function having both diverging and converging optical characteristics, and is disposed between the at least one lens and the image sensor.

In some cases, the imaging system further includes a cover glass disposed over the image sensor, and the meta optical element is disposed on the cover glass. In other cases, the meta optical element is disposed on the image sensor. In some instances, the image sensor is composed of semiconductor material, and the meta optical element is etched into the semiconductor material.

Some implementations include one or more of the following advantages. For example, in some cases, the meta optical element can be less bulky, and thinner, than a refractive lenses with a lens surface having the same, or substantially the same, diverging and converging phase function. In some cases, the meta optical element can be composed of a material that is less susceptible to thermal distortions due to temperature changes induced, for example, by electronic circuitry in close proximity to the meta optical element. That is, refractive lenses, which typically are composed of a polymeric material, may exhibit thermal distortion because polymers have high coefficients of thermal expansion. Further, S-shaped lenses may be particularly susceptible to thermal distortions because their complex shape is more prone to warping. Moreover, in some cases, it may be difficult to bias an S-shaped lens to accommodate this warping because of its complex shape. As the S-shaped refractive lenses exhibit a high degree of curvature, any thermally induced distortions to these lens surfaces are more likely to generate more significant degradation of optical performance compared, for example, to metalenses with less curvature. In some instances, using the meta optical element can correct for spherical aberrations. Further, in some cases, the meta optical element can have better manufacturing tolerances. Thus, tooling and other manufacturing costs for producing meta optical elements may be lower than the costs to produce more complex shaped lenses.

Other aspects, features and advantages will be readily apparent from the following detailed description, the accompanying drawings, and the claims.

### BRIEF DESCRIPTION OF THE DRAWINGS

FIG. 1 illustrates an example of a camera including a lens system.

FIG. 2 shows an example of a phase function of a metalens.

FIG. 3 is a flow chart illustrating an example of a method for designing a meta optical element having a diverging and converging phase function.

FIG. 4 shows an example of a camera including a metalens having a diverging and converging phase function.

FIG. 5 shows another example of a camera including a metalens having a diverging and converging phase function.

FIG. 6 shows a further example of a camera including a metalens having a diverging and converging phase function.

FIG. 7 shows another example of a camera including a metalens having a diverging and converging phase function.

FIG. 8 shows yet another example of a camera including a metalens having a diverging and converging phase function.

FIG. 9 shows a further example of a camera including a metalens having a diverging and converging phase function.

### DETAILED DESCRIPTION

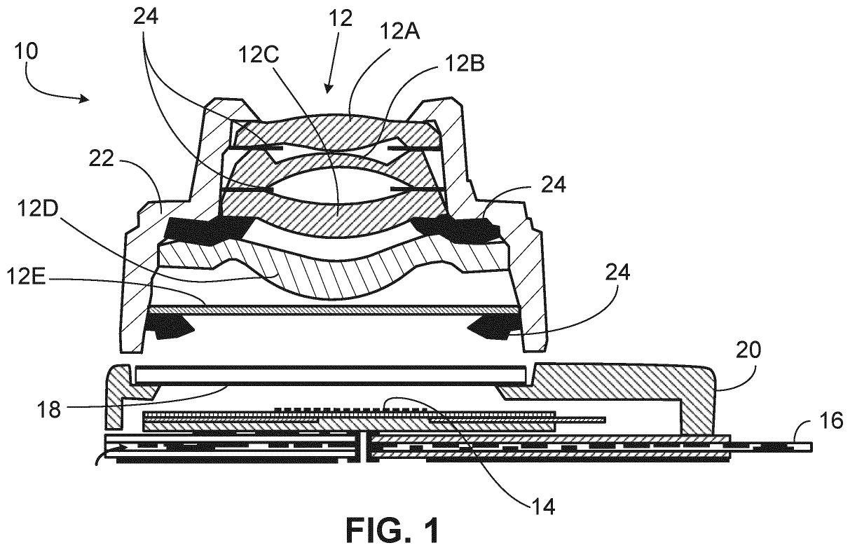

As shown in FIG. 1, a camera or other imager 10 includes a lens system 12 that includes a stack of refractive lenses 12A, 12B, 12C, 12D, and a meta optical element (e.g., a metalens) 12E optically aligned with the refractive lenses. The meta optical element can include a metasurface, which refers to a surface with distributed small structures (e.g., meta-atoms) arranged to interact with light in a particular manner. For example, a metasurface, which also may be referred to as a metastructure, can be a surface with a distributed array of nanostructures. The nanostructures may, individually or collectively, interact with light waves. For example, the nanostructures or other meta-atoms may change a local amplitude, a local phase, or both, of an incoming light wave. In FIG. 1, the meta-atoms (e.g., nanostructures) of the metasurface function as a lens. In particular, the metalens (or other meta optical element) 12E has a phase function having both diverging (i.e., dispersive) and converging optical characteristics and can function as field corrector lens that counters the field-angle dependence of the focal length of the system. In some instances, the metalens 12E is composed of an inorganic material. In some implementations, the metalens 12E is composed of amorphous silicon on a glass substrate. In some instances, the metalens 12E is etched into a semiconductor material. The meta optical element 12E can be relatively thin and flat.

Although the lens system 12 of FIG. 1 has four refractive lens, there may be fewer or more refractive lenses in other implementations. In any event, the refractive lenses 12A, 12B, 12C, 12D can be composed, for example, of a glass or polymer material. Some of the refractive lenses (e.g., 12A, 12D) may have a relatively high index of refraction to improve image quality and to reduce focus shift that otherwise may be caused by temperature changes.

The lens system 12, including the metalens 12E, is optically aligned with an image sensor 14 mounted, for example, on a printed circuit board (PCB) or other substrate 16. The PCB 16 may include one or more layers, such as a flexible core and metallization (e.g., copper wiring), as well as electrically conductive vias. The image sensor 14 can be implemented, for example, as a CMOS imager.

In some instances, a glass plate 18 having an infra-red (IR) or other optical filter may be disposed between the lens system 12 and the image sensor 14. The glass plate 18 can be supported, for example, by part of a plastic or other housing 20 that laterally surrounds the image sensor 14. The refractive lenses 12A, 12B, 12C, 12D and the metalens 12E can be contained, for example, in a lens barrel 22, and can be supported, respectively, by spacers 24 composed, for example, of plastic or silicon.

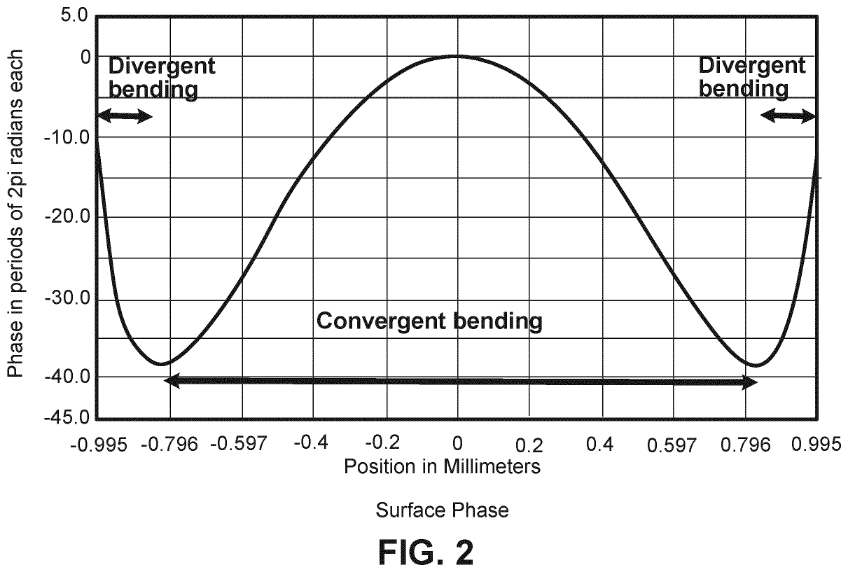

FIG. 2 illustrates an example of a phase function of the metalens 12E. The illustrated phase function has both divergent and convergent optical characteristics. In general, the derivative of the phase function at a particular point on the metalens 12E determines whether the phase function at that point is divergent or convergent. In the illustrated example, the phase function has a diverging optical characteristic near a periphery of the metalens and a converging optical characteristic near a center region of the metalens. In some implementations, details of the phase function of the metalens may differ from the example shown in FIG. 2.

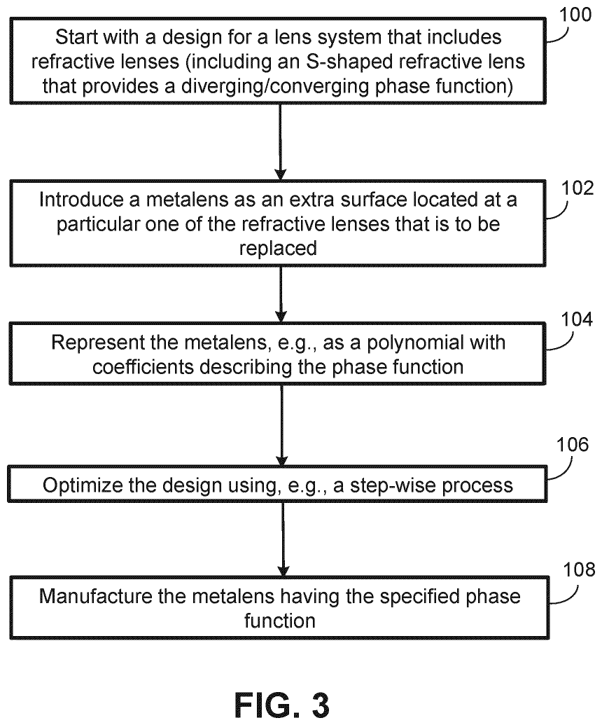

FIG. 3 is a flow chart illustrating an example of a method for designing a meta optical element (e.g., a metalens) having an appropriate phase function (i.e., a diverging/converging phase function). As indicated by 100, the process can start with a design for a lens system that includes refractive lenses that provide a particular optical function. It is assumed that one of the refractive lenses is an S-shaped refractive lens that has a particular diverging/converging phase function. Next, as indicated by 102, a meta optical element (e.g., a metalens) is introduced as an extra surface located at a particular one of the refractive lenses that is to be replaced (i.e., the S-shaped refractive lens that has a particular diverging/converging phase function). As indicated by 104, the meta optical element can be represented, for example, as a binary 2/hologram surface; that is, it can be represented as a polynomial with coefficients describing the phase function. Next, as indicated by 106, the design is optimized by target zero values of refractive asphere coefficients, conic constant and radius. The variables of the coefficients of the phase function also are set. The foregoing operations can be performed step-wise until the refractive lens that is to be replaced by the meta optical element is converted into a substantially flat piece of polymer. Details of the ray bending (e.g., incoming angle versus outgoing angle) for the metasurface can be determined, for example, using software (e.g., Zemax OpticStudio® optical design software). As indicated by 108, a meta optical element (e.g., metalens) having the specified phase function can be manufactured. As a result, a phase function describing the same properties as the S-shape lens with converging and diverging parts can be created and can function as the new optical element without loss of image performance.

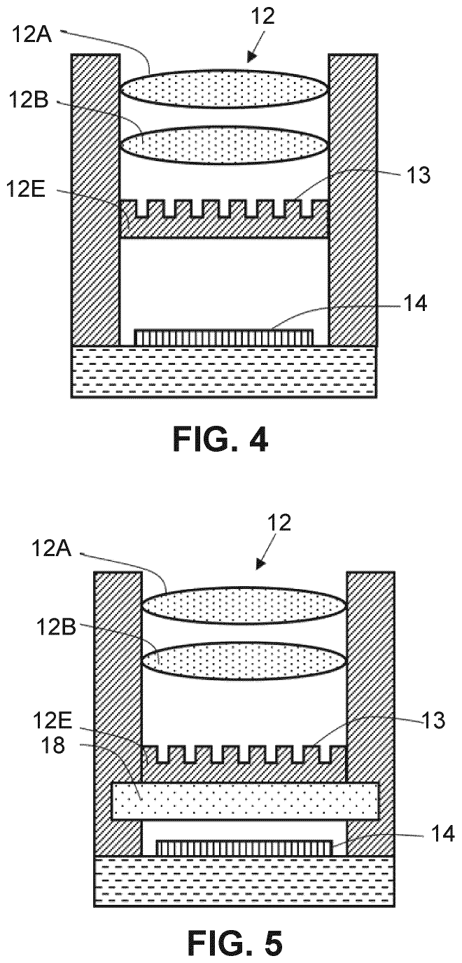

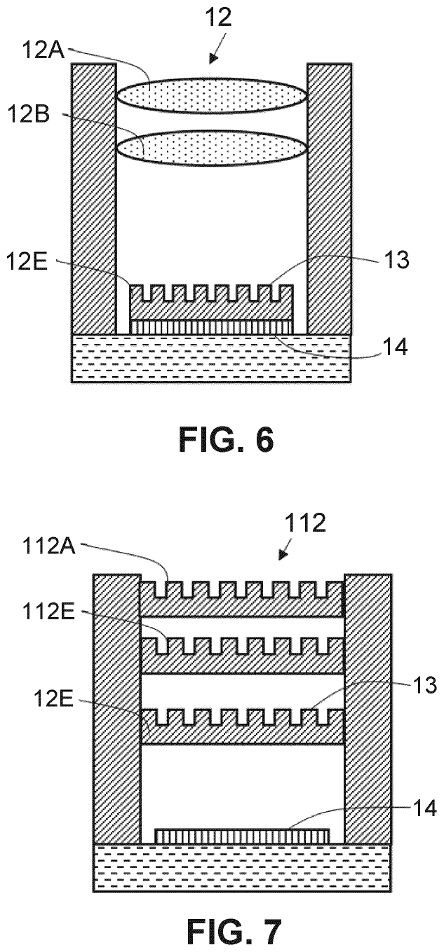

The meta optical element 12E having a metasurface that provides a diverging and converging phase function can be disposed in any one of various positions relative to other components of the camera. Thus, as shown in the example of FIG. 4, the metasurface 13 of the metalens 12E faces the refractive lenses 12A, 12B in the lens stack 12, and the metalens 12E is disposed between the refractive lenses 12A, 12B and the image sensor 14. On the other hand, in the example of FIG. 5, a cover glass 18 is disposed between the lens stack 12 and the image sensor 14, and the metalens 12E is deposited on the cover glass. In the example of FIG. 6, the metalens 12E is disposed between the refractive lenses 12A, 12B and the image sensor 14, and the metalens 12E is deposited on the image sensor 14 or etched directly into the image sensor semiconductor material.

Although the foregoing examples describe implementations having a lens system (e.g., a lens stack) that includes one or more refractive lenses 12A, 12B, more generally, the lens system can include at least one of a refractive lens, a diffractive lens, a GRIN lens, or a metalens. The lens system can include a plurality of a particular type of lens (e.g., multiple metalenses) and/or a combination of different types of lenses. FIGS. 7, 8 and 9 illustrate examples.

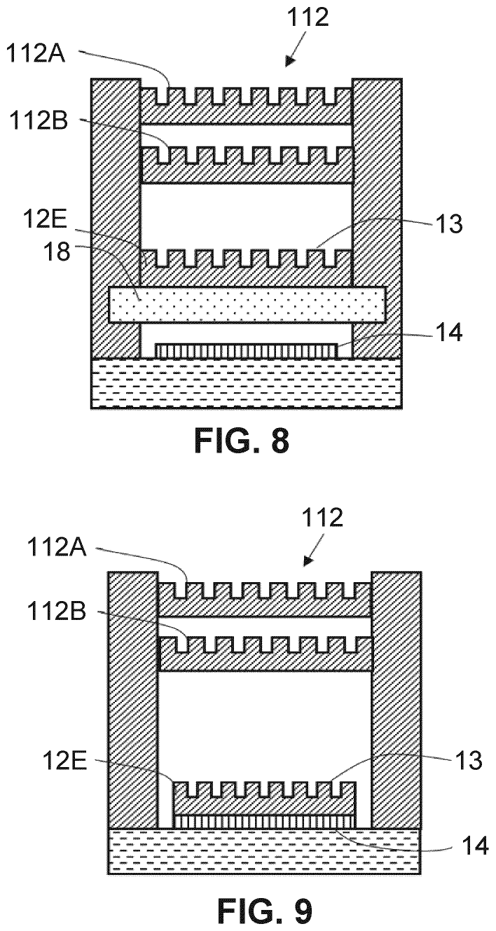

As shown in the examples of FIGS. 7, 8 and 9, the lens system 112 includes a stack of multiple lenses (e.g., metalenses, diffractive lenses, GRIN lenses, and/or refractive lenses) 112A, 112B, in addition to the metalens 12E that provides the diverging and converging phase function. In FIG. 7, the metasurface 13 of the metalens 12E faces the lenses 112A, 112B in the lens stack 112, and the metalens 12E is disposed between the lenses 112A, 112B and the image sensor 14. On the other hand, in the example of FIG. 8, a cover glass 18 is disposed between the lens stack 112 and the image sensor 14, and the metalens 12E is deposited on the cover glass 18. Placing the metalens 12E on the cover glass 18 may be helpful in some cases to correct field curvature close to the sensor 14. In some instances, however, an air gap may be present between the metalens 12E and the coverglass 18. In the example of FIG. 9, the metalens 12E is disposed between the lenses 112A, 112B and the image sensor 14, and the metalens 12E is deposited on the image sensor 14 or etched directly into the image sensor semiconductor material.

The various camera and imaging systems described above can be incorporated, for example, into a smart phone or other portable computing device.

Various modifications will be readily apparent from the foregoing description. Accordingly, other implementations are also within the scope of the claims.

1. An apparatus comprising:
a meta optical element having a phase function that has both diverging and converging optical characteristics.

2. The apparatus of claim 1 wherein the meta optical element comprises a metalens.

3. The apparatus of claim 1, wherein the meta optical element has a metasurface comprising meta-atoms.

4. The apparatus of claim 1, wherein the meta optical element is composed of an inorganic material.

5. The apparatus of claim 1, wherein the meta optical element is composed of silicon on a glass substrate.

6. The apparatus of claim 1, wherein the phase function has a diverging optical characteristic near a periphery of the meta optical element and a converging optical characteristic near a center region of the meta optical element.

7. The apparatus of claim 1, further comprising:
a lens system including at least one lens; and
wherein the meta optical element is optically aligned with the at least one lens.

8. The apparatus of claim 7 wherein the at least one lens includes at least one of a refractive lens, a diffractive lens, a GRIN lens, or a metalens.

9. The apparatus of claim 7 wherein the at least one lens includes a metalens.

10. The apparatus of claim 7 wherein the lens system includes a stack of refractive lenses.

11. The apparatus of claim 7, further including an image sensor optically aligned with the lens system and the meta optical element.

12. An imaging system comprising:
a lens system including at least one lens; and
a meta optical element optically aligned with the at least one lens, wherein the meta optical element has a phase function having both diverging and converging optical characteristics;
an image sensor optically aligned with the lens system and the meta optical element,
wherein the meta optical element is disposed between the at least one lens and the image sensor.

13. The imaging system of claim 12 further including a cover glass disposed over the image sensor, wherein the meta optical element is disposed on the cover glass.

14. The imaging system of claim 12 wherein the meta optical element is disposed on the image sensor.

15. The imaging system of claim 12, wherein the image sensor is composed of semiconductor material, and wherein the meta optical element is etched into the semiconductor material.

16. The imaging system of claim 12, wherein the meta optical element comprises a metalens.

17. The imaging system of claim 12, wherein the meta optical element has a metasurface comprising meta-atoms.

18. The imaging system of claim 12, wherein the meta optical element is composed of an inorganic material.

19. The imaging system of claim 12, wherein the meta optical element is composed of silicon on a glass substrate.

20. The imaging system of claim 12, wherein the phase function has a diverging optical characteristic near a periphery of the meta optical element and a converging optical characteristic near a center region of the meta optical element.

21. The imaging system of claim 12, wherein the at least one lens includes at least one of a refractive lens, a diffractive lens, a GRIN lens, or a metalens.

22. The imaging system of claim 12, wherein the at least one lens includes a metalens.

23. The imaging system of claim 12, wherein the lens system includes a stack of refractive lenses.
